(19) United States
(12) Patent Application Publication
(10) Pub. No.: US 2026/0368162 A1
(43) Pub. Date: Nov. 19, 2026

(54) DATA RECALL USING CLUSTER-BASED EMBEDDINGS

(71) Applicant: eBay Inc., San Jose, CA (US)

(72) Inventor: Ying Ma, Shanghai (CN)

(73) Assignee: eBay Inc., San Jose, CA (US)

(21) Appl. No.: 19/211,848

(22) Filed: May 19, 2025

(51) Int. Cl. G06F 16/2452; G06F 16/28

(52) U.S. Cl. CPC G06F 16/24522; G06F 16/285

(57) ABSTRACT

Techniques for data recall using cluster-based embeddings are described. In one or more implementations, embeddings are generated for data columns based on descriptions associated with the data columns. Clusters of the data columns are formed based on the embeddings, and center embeddings for the clusters are defined. Data tables that include the data columns are represented using the center embeddings. A request embedding is generated from an information request, and similarity between the request embedding and the center embeddings is determined in an embedding space. One or more data tables that include information relating to the information request are identified based on the determined similarity, and a result including the information is output.

### BACKGROUND

Systems that use natural language input for data queries face numerous challenges. Data queries can be information requests that include text describing data to be retrieved from a database or other data storage. The text included in such information requests can be phrased in numerous ways, which can lead to unpredictable data retrieval. For example, two separate information requests can be configured with text content that is semantically similar, yet differences of the phrasing of the text can result in retrieval of different data for the requests. One aspect that contributes to such issues is that descriptions of data tables and data columns are often relied upon for accurate identification of data relevant to a request. However, such descriptions are often short or incomplete, which can lead to unintentional mismatching of requests with irrelevant descriptions and/or unintentional overlooking of descriptions relevant to the requests. Some approaches attempt to address such problems by merging all of the descriptions of a data table. However, such approaches discard the specificity of the individual descriptions and can cause difficulty with identification of data structures that include the requested data.

### SUMMARY

Techniques for data recall using cluster-based embeddings are described. In one or more implementations, embeddings are generated for data columns based on descriptions associated with the data columns. Clusters of the data columns are formed based on the embeddings, and center embeddings for the clusters are defined. Data tables that include the data columns are represented using the center embeddings. A request embedding is generated from an information request, and similarity between the request embedding and the center embeddings is determined in an embedding space. One or more data tables that include information relating to the information request are identified based on the determined similarity, and a result including the information is output.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the techniques for data recall using cluster-based embeddings described herein.

FIG. 2 depicts an example showing an implementation of table data used by a query service of FIG. 1 in greater detail.

FIG. 3 depicts an example showing an implementation of the query service of FIG. 1 in greater detail as employed to generate cluster data and center embedding data.

FIG. 4 depicts an example 300 showing an implementation of the query service of FIG. 1 in greater detail as employed to output a result based on an information request.

FIG. 5 depicts a system in an example implementation showing operation of the query service of FIG. 1 in greater detail as employed to perform data recall using cluster-based embeddings.

FIG. 6 is a flow diagram depicting an algorithm as a step-by-step procedure in an example implementation of operations performable for accomplishing a result of data recall using cluster-based embeddings.

FIG. 7 illustrates an example system including various components of an example device that can be implemented as any type of computing device as described and/or utilized with reference to FIGS. 1-5 to implement embodiments of the techniques described herein.

### DETAILED DESCRIPTION

### Overview

Retrieval of data from large data storage systems, such as databases, involves data queries implemented using a computing device. A variety of techniques may be used. For instance, some data storage systems are configured to process commands provided in a query language for retrieval of data. One such query language is structured query language, also referred to as SQL. Query language commands can be useful when the location of particular data in a data storage system is known. However, in some situations, the amount of data stored by a data storage system can be overwhelming for users and there is often uncertainty as to the particular location of information among thousands of data cells or more. Additionally, forming data queries using query language can involve specialized knowledge that may not be available to some users.

Some approaches to address these issues involve systems configured to receive information requests including natural language input, such as text, and translate the natural language input to commands in a query language. For instance, a text-to-SQL system can be configured to receive natural language input that has a conversational semantic quality. The system interprets words, phrases, sentences, and so forth included in the content of the natural language input and generates query language commands for retrieval of data from the data storage based on the natural language input. The retrieved data is then provided to a user, for instance.

However, such approaches are not without challenges. For instance, such systems often rely on descriptions, e.g., table metadata, associated with data in the data storage. Typically, the systems convert natural language input to one or more vectors that can be compared to other vectors representing the descriptions. Descriptions that have content semantically similar to the content of the natural language input can be identified, and the location of data associated with the descriptions can be determined. In many cases, however, the descriptions are incomplete, semantically sparse, or are otherwise not sufficiently detailed to account for the diverse content that can be described using natural language. Some systems combine all of the descriptions associated with a data table into a single combined description, but this can result in inaccurate comparison results and dilute the particular semantic characteristics of the individual descriptions.

In order to address such issues, techniques and systems for data recall using cluster-based embeddings are described. In one or more examples, a system generates embeddings for data columns of a data table based on descriptions associated with the data columns. Based on the embeddings, clusters of the data columns are formed. The clusters include the embeddings associated with the data columns. Forming the clusters can be based on similarity determined between the embeddings. For instance, embeddings that are similar to an extent that is greater than a threshold similarity can be used to form the clusters. Clusters that include multiple embeddings thus represent multiple data columns. Additionally, respective center embeddings are defined for the clusters. For instance, a center embedding associated with a cluster can be an average of the embeddings included by the cluster. The center embeddings can thus be employed to represent the tables that include the columns.

A user, for instance, may interact with the system by providing natural language input describing an information request. When the information request is received, a request embedding is generated that encodes the semantic content of the natural language input in an embedding space, e.g., a multi-dimensional latent space. Similarity between the request embedding and the center embeddings is determined in the embedding space. Based on the similarity, one or more of the data tables that include information relating to the request are identified. The information is retrieved and output in a result presented to the user, for instance. The described techniques thus involve representing data tables using the center embeddings associated with the clusters. As a result, an accuracy of data retrieval based on natural language input can be increased.

Consider a scenario in which a data table includes many data columns, e.g., one hundred data columns. In this example scenario, the description of one of the data columns is semantically sparse relative to other data columns. Although the data column with the semantically sparse description may include information relevant to an information request based on natural language input, conventional techniques may fail to identify the data table as including the information due to the sparse description.

However, the described techniques can increase the accuracy of data recall in such scenarios. To do so, similarity is determined between the embeddings representing descriptions associated with the data columns. A cluster of data columns is formed based on similarity between the embeddings. In this example scenario, the cluster includes the embedding associated with the semantically sparse description and also includes other embeddings. A center embedding is defined for the cluster as the average of the embeddings in the cluster. Responsive to receiving natural language input describing a data retrieval request, the embedding representing the natural language input can be compared to the center embedding. The data table represented by the center embedding can thus be identified as including information relating to the information request despite the semantically sparse description associated with the individual embedding. Accordingly, the requested information is retrieved from the corresponding data column of the data table and output in a result for presentation, e.g., via a display device.

The described techniques can additionally reduce response times associated with data retrieval. For instance, comparing the request embedding with the center embeddings can be performed more quickly than comparing the request embedding with the individual embeddings. The reduced response times can accordingly increase system responsiveness and decrease a computational load of the system, thereby increasing availability of system resources such as memory and/or communication bandwidth for other operations.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Data Recall Using Cluster-Based Embeddings Environment

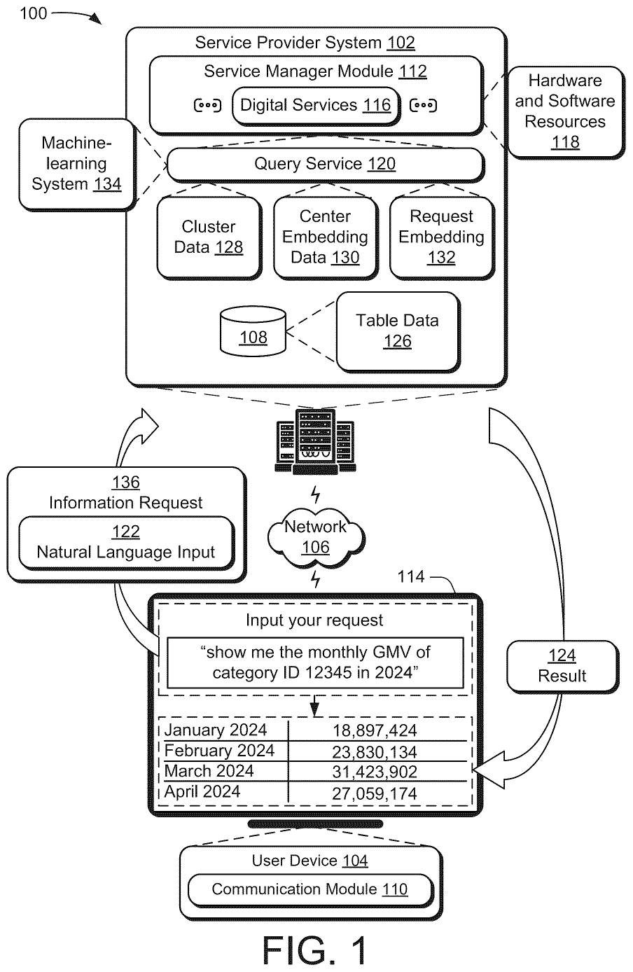

FIG. 1 is an illustration of a digital medium environment 100 in an example implementation that is operable to employ the techniques for data recall using cluster-based embeddings described herein. The illustrated environment 100 includes a service provider system 102 and a user device 104 that are communicatively coupled, one to another, via a network 106. Computing devices that implement the service provider system 102 and the user device 104 are configurable in a variety of ways.

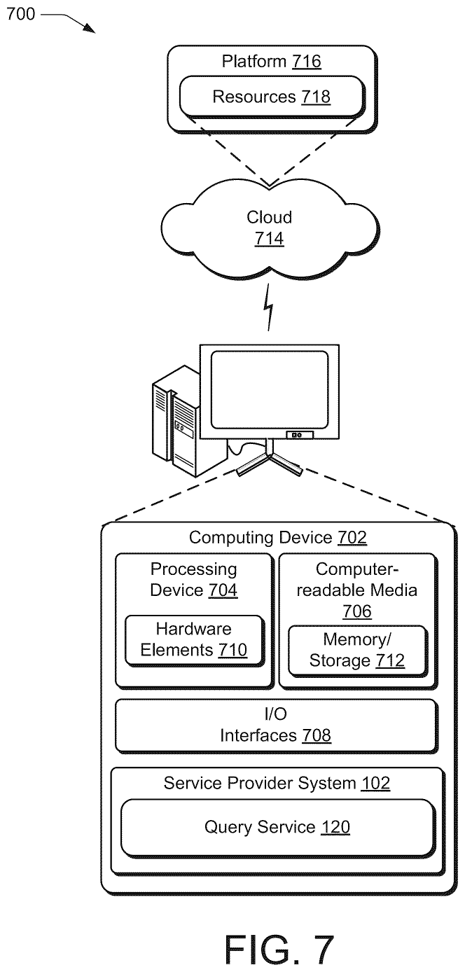

A computing device, for instance, is configurable as a desktop computer, a laptop computer, a mobile device (e.g., assuming a handheld configuration such as a tablet or mobile phone as illustrated), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown, a computing device is also representative of a plurality of different devices, such as multiple servers utilized by a business to perform operations “over the cloud” as described in FIG. 7.

The service provider system 102 supports the modules and systems described herein to implement a platform accessible to end users via other electronic devices such as personal computers, smartphones, and so forth. For instance, the service provider system 102 is configurable to include electronic storage media, transitory memory and non-transitory memory, one or more electronic processors, and other components configured to facilitate operation of the platform. The platform is accessible to users over the network 106. In some instances, the network 106 can be the internet, and the service provider system 102 implements the platform as a website.

In the depicted implementation, the service provider system 102 includes a storage device 108 employed for storage of data using memory or other storage media. The data can include, for instance, data associated with operation of the service provider system 102, data relating to content provided by the service provider system 102 to end users, and so forth.

The user device 104 includes a communication module 110 that is representative of functionality to communicate via the network 106 with a service manager module 112 of the service provider system 102, e.g., as a browser, a network-enabled application, and so on. The user device 104 can display content received over the network 106 from the service provider system 102. Such content can include, for instance, data retrieved from the storage device 108. The user device 104 can be a smartphone, personal computer, tablet, or other type of computing device employing a display device 114 (e.g., a display screen) to display the content received from the service provider system 102. The user device 104 can further include memory or other storage configured to store such content.

The service manager module 112 of the service provider system 102 is configured to implement digital services 116 using hardware and software resources 118, e.g., a processing device and a computer-readable storage medium. Digital services 116 are usable to expose a variety of functionality to the user device 104 via the network 106 through execution by computing devices at the service provider system 102. Examples of digital services include social media services, digital content creation services, streaming services, digital content storage services, and so forth.

A query service 120, for instance, is an example of the digital services 116 that supports functionality involving the retrieval of information from the storage device 108. The query service 120 is implemented at least partially in hardware of the service provider system 102 to receive input, such as information requests. In the depicted example, an information request 136 received by the query service 120 includes natural language input 122. The query service 120 is operable to output results based on the input, such as result 124. The results include information recalled (e.g., retrieved) from one or more data tables maintained as table data 126 in a storage device accessible to the service provider system 102, such as storage device 108. The information included in the result 124 is determined by the query service 120 based on cluster data 128, center embedding data 130, and the natural language input 122.

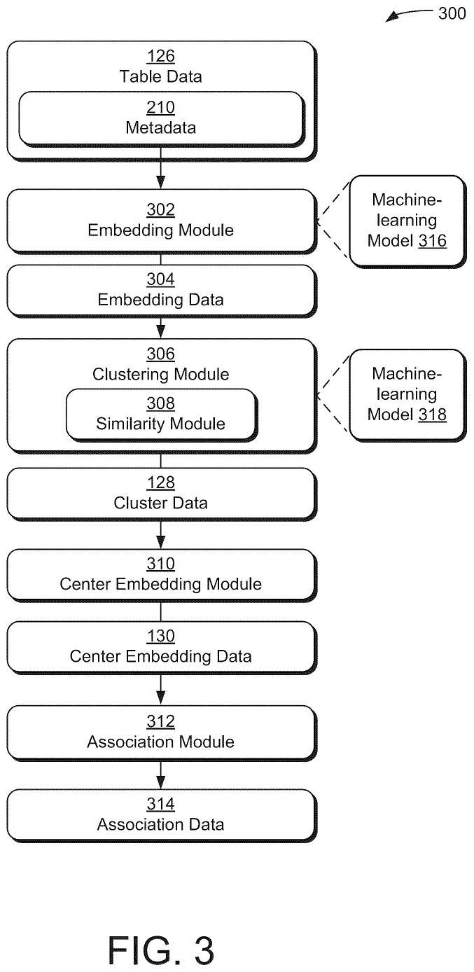

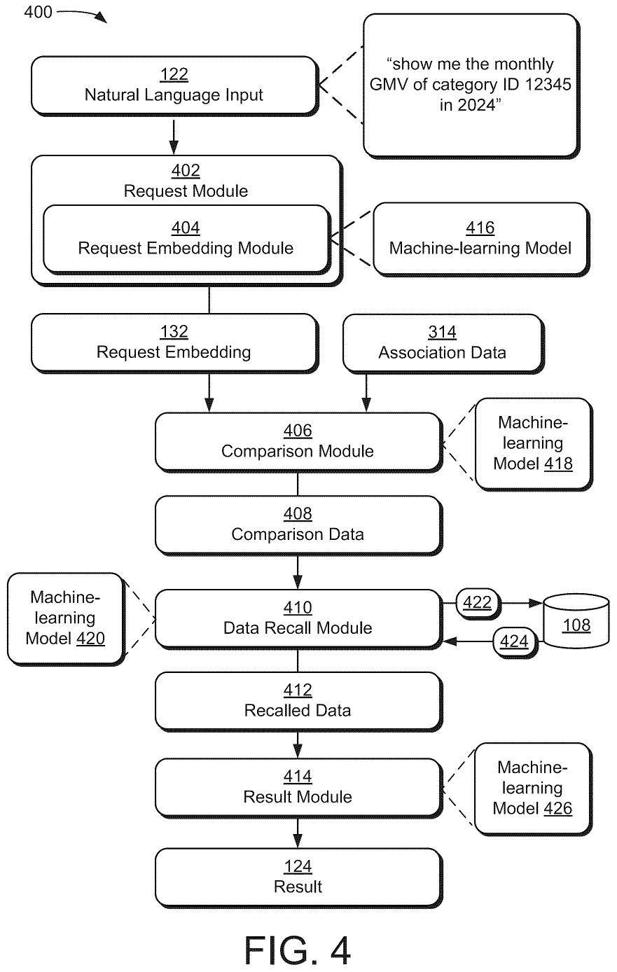

The query service 120 implements a machine-learning system 134 including one or more machine-learning models employed to perform various operations in accordance with the described techniques. The machine-learning system 134 is implemented at least partially in hardware of the service provider system 102. Examples of machine-learning models that may be employed by the machine-learning system 134 are described further below with reference to FIGS. 3-4. Although the machine-learning models are described separately, in some instances two or more of the described machine-learning models may be combined as a single machine-learning model configured to perform the described operations.

One or more of the machine-learning models of the machine-learning system 134 are trained to process the natural language input 122 for recall (e.g., retrieval) of the information from the storage device 108. The query service 120 is operable to employ the one or more machine-learning models to generate queries in a query language (e.g., structured query language, or SQL) based on the natural language input 122. The queries are executable to support the recall of the information from the storage device 108.

The query service 120 generates the cluster data 128 using the table data 126. To do so, the query service 120 generates embeddings based on descriptions associated with the data columns described by the table data 126. In some instances, the query service generates a respective embedding for each data column description. The query service 120 additionally determines similarity between the embeddings. The query service 120 defines clusters (e.g., groups) of the embeddings based on the similarity between the embeddings. The cluster data 128 describes the clusters defined by the query service 120.

The query service 120 generates the center embedding data 130 using the cluster data 128. To do so, the query service 120 generates center embeddings based on the embeddings included by the clusters. Each center embedding represents a corresponding cluster described by the cluster data 128. A center embedding is an average of the embeddings included in a cluster. The query service 120 can determine the average of the embeddings included in a cluster using various averaging techniques. For instance, the query service is operable to generate a center embedding associated with a cluster by calculating a mean of the embeddings included in the cluster.

The cluster data 128 and the center embedding data 130 are employed by the query service 120 for identifying information included in the table data 126. In particular, the query service 120 is operable to receive information requests and output results that include information identified from the table data 126 based on the information requests. In the depicted example, the query service 120 receives natural language input 122 describing an information request. The natural language input 122 is communicated from the user device 104 to the query service 120 using the network 106. The natural language input 122 includes words, phrases, and/or sentences describing requested information.

The depicted natural language input 122 of the information request 136 specifies “show me the monthly GMV of category ID 12345 in 2024.” Such a request can involve information stored in multiple tables, e.g., a transaction table including a “GMV” description, a date table including a “Begin_month_date” description, and a category table including a “category ID” description. However, some approaches may be unable to accurately identify the tables that include information relevant to the information request. For instance, approaches that combine all the descriptions associated with a table tend to dilute the specific semantic characteristics associated with each individual description. Such dilution can result in mismatches between a vector representing the combined descriptions and the vector representing the natural language input. As a result, retrieval of the desired information based on the natural language input may be impeded.

The described techniques for data recall using cluster-based embeddings address such issues. In particular, the query service 120 is configured to process the natural language input 122 and identify the requested information in the table data 126. To do so, the query service 120 generates a request embedding 132 from the natural language input 122 and compares the request embedding 132 to the center embeddings described by the center embedding data 130. For instance, the query service 120 is operable to determine similarity between the request embedding 132 and the center embeddings. The query service 120 recalls information from the table data 126 based on the center embeddings that have similarity to the request embedding 132. To do so, the query service 120 generates a query in a query language based on the natural language input 122 and the identified information in the table data 126. The query includes query language commands such as SQL commands, for instance.

As an example, the natural language input 122 specifying “show me the monthly GMV of category ID 12345 in 2024” is used to generate the request embedding 132 as described above. Based on the request embedding 132, information relating to the request is identified in the table data 126 using the center embeddings. Based on the natural language input 122 and the location of the identified information, the query service 120 generates the query in the query language. The query is executed to retrieve the information from the storage device 108. The retrieved information is output in the result 124. Accordingly, the query service 120 reduces or eliminates the occurrences of retrieval of unrelated or unhelpful information that can occur with conventional approaches, and information retrieval accuracy is increased.

In the depicted example, the result 124 generated by the query service 120 includes the requested information. In particular, the result 124 presents the monthly gross merchandise value (GMV) in the year 2024 associated with a category having an identification number (ID) of 12345. The result 124 is output to the user device 104 and is displayed via the display device 114 of the user device 104. Although illustrated as implemented locally at the service provider system 102, functionality of the query service 120 is also configurable as whole or part via functionality available via the network 106, such as part of a web service or “in the cloud.” In the following discussion, techniques to generate the cluster data 128, the center embedding data 130, and the result 124 are described in greater detail.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Data Recall Using Cluster-Based Embeddings

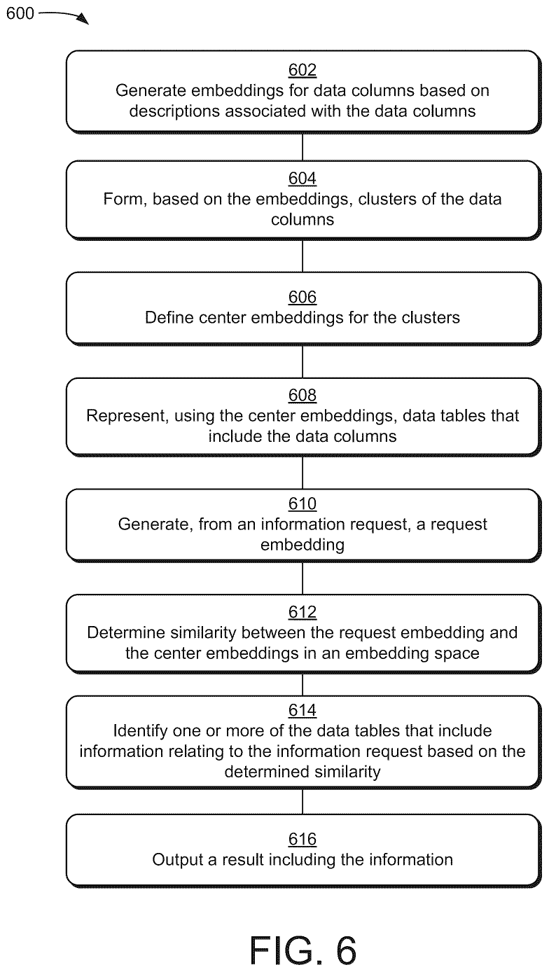

The following discussion describes techniques for data recall using cluster-based embeddings that are implementable utilizing the described systems and devices. Aspects of each of the procedures are implemented in hardware, firmware, software, or a combination thereof. The procedure is shown as a set of blocks that specify operations performable by hardware and are not necessarily limited to the orders shown for performing the operations by the respective blocks. Blocks of the procedure, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-5 in parallel with FIG. 6. FIG. 6 is a flow diagram depicting an algorithm 600 as a step-by-step procedure in an example implementation of operations performable for accomplishing a result of data recall using cluster-based embeddings.

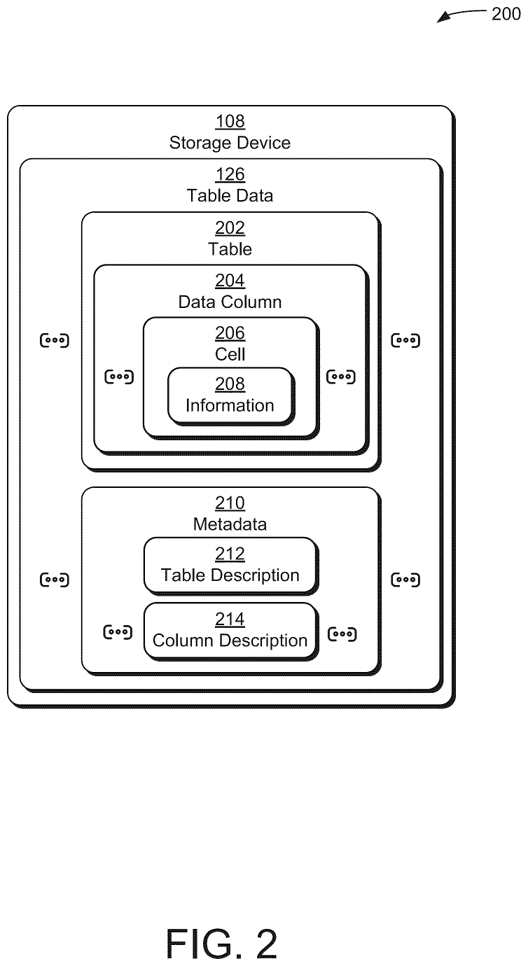

FIG. 2 depicts an example 200 showing an implementation of table data 126 used by the query service 120 of FIG. 1 in greater detail. In the depicted example, the table data 126 is stored by the storage device 108. The table data 126 defines at least one table 202. The table 202 defines at least one data column 204 and at least one cell 206. The depicted cell 206 is included by the data column 204 and stores information 208. The information 208 is configurable as textual information (e.g., one or more strings) or numerical information (e.g., a number or set of numbers). In some instances, the information 208 is configurable as a combination of textual information and numerical information.

The table data 126 further includes metadata 210. The metadata 210 is associated with the table 202 and includes a table description 212 and at least one column description 214. The table description 212 and column description 214 are configurable in a variety of ways. For instance, the table description 212 and column description 214 are configurable as characters (e.g., letters and/or numbers) describing the contents of the table 202 and the data column 204, respectively.

In an example, the data column 204 is one of multiple data columns included by the table 202. Each data column includes one or more cells, such as the cell 206. Each cell includes respective information, such as information 208. Each data column is associated with a respective column description 214 included by the metadata 210, such as the column description 214. The table description 212 of the metadata 210 generally describes the contents of the cells of the table 202. For instance, the table description 212 is configurable to specify that the cells of the table 202 include information relating to subjects such as shipments, transactions, and so forth.

The column descriptions of the metadata describe contents of subsets of cells of the table 202. Continuing the above example, the column description is configurable to specify that the cell 206 and other cells of the data column 204 include information relating to a particular aspect of shipping or transactions. For instance, the column description 214 is configurable to specify that the cells of the data column 204 include information relating to recipients or product providers. The table description 212 thus generally indicates the contents of the cells of the table 202 while the column descriptions indicate the contents of specific subsets of the cells of the table 202.

FIG. 3 depicts an example 300 showing an implementation of the query service 120 of FIG. 1 in greater detail as employed to generate cluster data and center embedding data. To begin in this example, the storage device 108 is depicted storing the table data 126. The table data 126 includes metadata 210 as described above. The table data 126 is received by an embedding module 302 implemented by the query service 120. The embedding module 302 processes the table data 126 to generate embedding data 304. In particular, the embedding module 302 generates the embedding data 304 using the metadata 210 included by the table data 126. To do so, the embedding module 302 may employ one or more machine-learning models of the machine-learning system 134, such as machine-learning model 316. The machine-learning model 316 may be a generative model such as a retrieval-augmented generation (RAG) model, for instance.

The embedding data 304 includes one or more embeddings (e.g., vectors) that are generated by the embedding module 302 to represent descriptions included by the metadata of the table data 126, such as metadata 210. For instance, the embedding data 304 includes an embedding representing the table description 212 and another embedding representing the column description 214. As described above, the metadata 210 is configurable to include a respective column description for each data column included by the table 202. As such, the embedding data 304 is configurable to include a respective embedding for each column description. Further, the table 202 is one example table defined by the table data 126, and the table data 126 is configurable to define additional tables. The embedding data 304 is also configurable to include a respective embedding for each table description.

The embeddings included by the embedding data 304 are generated from the content of the descriptions of the tables and data columns included by the table data 126 (block 602). In particular, the embeddings are numerical representations of the descriptions based on the characters forming the descriptions. Descriptions that are formed from different combinations of characters result in different embeddings once processed by the embedding module 302. The embedding module 302 is thus operable to transform combinations of letters and/or numbers to embeddings in an embedding space.

The numerical representations of the descriptions via the embeddings in the embedding space enables the content of the descriptions to be compared computationally by way of comparison of the embeddings. Specifically, as each embedding represents a corresponding description, comparison of the embeddings is performed to accomplish comparison of the content of the descriptions. To do so, the query service 120 employs a clustering module 306 including a similarity module 308. The clustering module 306 receives the embedding data 304 and processes the embedding data 304 using the similarity module 308. The similarity module 308 compares the embeddings of the embedding data 304 to each other and determines an amount of similarity between pairs of embeddings. In particular, the similarity module 308 compares embeddings representing column descriptions to each other to determine which column descriptions in a given table have similar content.

The similarity module 308 is operable to determine the similarity between embeddings using one or more similarity algorithms or functions, e.g., a vector similarity function such as a cosine similarity function. For example, the similarity module 308 is configurable to determine a difference (e.g., vector difference) between a pair of embeddings and further determine a magnitude of the difference. Based on the magnitude of the difference, the similarity module 308 generates a similarity score associated with the pair of embeddings. The similarity module 308 is operable to generate a corresponding similarity score for each combination of embeddings.

In some instances, the similarity module 308 employs one or more machine-learning models to determine the similarity between the embeddings. In the depicted example, the similarity module 308 employs machine-learning model 318 which is implemented by the machine-learning system 134. The machine-learning model 318 may be, for instance, a neural network, convolutional neural network (CNN), long short-term memory (LSTM) neural network, generative adversarial network (GAN), or other type of model configured to determine similarity between the embeddings.

The clustering module 306 forms (e.g., defines) clusters of the data columns based on the embeddings (block 604). The clusters include embeddings that represent the column descriptions. The clusters are formed based on the similarity of the embeddings determined using the similarity module 308. In some instances, the clustering module 306 forms clusters of embeddings that have similarity scores that are greater than a threshold similarity score. The threshold similarity score can be pre-defined or based on the table data 126. In some instances, the clustering module 306 associates individual embeddings with two or more clusters.

As an example, the similarity module 308 determines a similarity score between a first embedding and a second embedding that is above the threshold similarity score. The similarity module 308 also determines a similarity score between the second embedding and a third embedding that is above the threshold similarity score. However, the similarity module 308 determines a similarity score between the first embedding and the second embedding that is below the threshold similarity score. The clustering module 306 processes the similarity scores and defines a first cluster that includes the first embedding and the second embedding. The clustering module 306 also defines a second cluster that includes the second embedding and the third embedding. As such, the second embedding is associated with each of the first cluster and the second cluster.

Accordingly, the clustering module 306 forms the clusters as groupings of embeddings that represent the data column descriptions. As the data column descriptions are associated with particular data columns, the clusters also represent groupings of the data columns themselves. In an example, a cluster formed by the clustering module 306 includes five embeddings. Each of the five embeddings represents a column description associated with a respective data column of a table, such as the table 202. The cluster thus represents a grouping of the five column descriptions and, by extension, a grouping of the five data columns associated with the column descriptions. Tables defined by the table data 126 can be associated with multiple clusters. In an example, the table 202 includes five or more data columns. Two of the data columns are associated with a first cluster and three of the data columns are associated with a second cluster. The table 202 thus is associated with (e.g., represented by) each of the first cluster and the second cluster.

The clustering module 306 outputs the clusters as cluster data 128, and the cluster data 128 is received by a center embedding module 310. The cluster data 128 includes, for instance, a list of clusters defined by the clustering module 306 and the embeddings associated with each of the clusters. The center embedding module 302 processes the cluster data 128 and determines center embeddings associated with the clusters based on the embeddings included by the clusters (block 606). The center embeddings are averages (e.g., vector averages) of the embeddings associated with the clusters. For instance, the center embeddings are configurable as weighted or non-weighted means of the embeddings.

Consider the example described above of the cluster including the five embeddings. The center embedding module 302 receives the cluster data 128 describing the cluster and the five embeddings associated with the cluster. The center embedding module 302 processes the cluster data 128 and generates a center embedding associated with the cluster. The center embedding is an average (e.g., a mean) of the five embeddings included by the cluster. For instance, the five embeddings are vectors, and the center embedding is another vector that is an average of the five vectors. The center embedding module 302 is operable to generate a respective center embedding for each of the clusters.

The center embeddings are output by the center embedding module 302 as center embedding data 304. The center embedding data is provided to an association module 312. The association module 312 outputs association data 314 describing the tables, the clusters associated with the tables, and the center embeddings associated with the clusters. As each cluster is associated with a center embedding, the association data 314 is configurable to at least partially represent the tables by way of the center embeddings (block 608). Consider the example described above in which the table 202 includes two data columns associated with the first cluster and three data columns associated with the second cluster. The first cluster is associated with a first center embedding representing an average of the embeddings associated with the two data columns related to the first cluster. The second cluster is associated with a second center embedding representing an average of the embeddings associated with the three data columns related to the second cluster. In this example, the table 202 is represented by the first center embedding and the second center embedding in the association data 314.

The association data 314 may be maintained in a storage accessible to the service provider system 102, such as the storage device 108. One or more machine-learning models of the machine-learning system 134, such as the machine-learning model 316 described above, may employ the association data 314 for performing various operations in accordance with the described techniques. For instance, the association data 314 may be compared with the request embedding 132 via one or more machine-learning models as described further below.

FIG. 4 depicts an example 400 showing an implementation of the query service of FIG. 1 in greater detail as employed to output a result based on an information request. To begin in this example, the natural language input 122 of the information request 136 is provided to a request module 402 implemented by the query service 120. The request module 402 includes a request embedding module 404 that the query service 120 employs to generate the request embedding 132 based on the natural language input 122 (block 610). The request embedding 132 encodes the content of the natural language input 122 in the embedding space, e.g., as a vector based on the content of the natural language input 122.

The request embedding module 404 employs one or more machine-learning models of the machine-learning system 134, such as machine-learning model 416, to process the natural language input 122 and generate the request embedding 132. The machine-learning model 416 may be, for instance, a retrieval-augmented generation model. In some instances, the machine-learning model 416 may be the same as the machine-learning model 316 described above.

The request embedding 132 is provided to a comparison module 406. The comparison module 406 additionally receives the association data 314. The comparison module 406 processes the request embedding 132 and the association data 314 to compare the request embedding 132 to the association data 314. In particular, the comparison module 406 is employed to determine similarity between the request embedding 132 and the center embeddings described by the association data 314 in an embedding space (block 612).

The comparison module 406 is operable to determine the similarity between request embedding 132 and the center embeddings using one or more similarity algorithms or functions, e.g., a vector similarity function such as a cosine similarity function. For example, the comparison module is configurable to determine a difference (e.g., vector difference) between the request embedding 132 and each of the center embeddings. Based on the magnitude of the difference, the comparison module 406 generates similarity scores indicating the similarity of the request embedding 132 to each of the center embeddings.

The comparison module 406 is operable to identify the center embeddings associated with similarity scores in relation to the request embedding 132 that are above a threshold similarity score. For instance, the threshold similarity score can be pre-defined or based on the natural language input 122. In some instances, the comparison module 406 employs one or more machine-learning models to determine the similarity between the request embedding 132 and the center embeddings. In the depicted example, the comparison module 406 employs machine-learning model 418 which is implemented by the machine-learning system 134. The machine-learning model 418 may be, for instance, a neural network, convolutional neural network (CNN), long short-term memory (LSTM) neural network, generative adversarial network (GAN), or other type of model configured to determine similarity between the request embedding 132 and the center embeddings. In some instances, the machine-learning model 418 may be the same as the machine-learning model 318 described above.

The comparison module 406 outputs comparison data 408 that specifies the identified center embeddings. In some instances, the comparison data 408 is configurable to include the center embeddings ordered (e.g., ranked) based on similarity of the center embeddings with the request embedding using the similarity scores.

The comparison data 408 is provided to a data recall module 410. The data recall module 410 recalls (e.g., retrieves) data from the storage device 108 based on the comparison data 408. The comparison data 408 specifies the center embeddings that are associated with similarity scores in relation to the request embedding 132 that are above the threshold similarity score as described above. The comparison data 408 is further configurable to specify the data tables associated with the center embeddings. As described above, the center embeddings are generated based on clusters of embeddings, and the clusters of embeddings are generated from data columns of data tables. In some instances, for each center embedding specified by the comparison data 408, the comparison data 408 additionally specifies the data table that includes the data columns associated with embeddings that form the basis for that center embedding. As an example, the comparison data 408 is configurable to indicate that one or more of the specified center embeddings similar to the request embedding 132 are associated with the table 202 (block 614).

The data recall module 410 recalls data (e.g., information 208) from the data tables associated with the center embeddings specified by the comparison data 408. Recalled data 412 is a portion of the data stored in the table data 126 that is relevant to the information request described by the natural language input 122. The data recall module 410 employs one or more machine-learning models implemented by the machine-learning system 134, such as machine-learning model 420, for retrieval of data from the data tables.

In the depicted example, the data recall module 410 employs machine-learning model 420 to generate a query 422 communicated to the storage device 108. At least a portion of the query 422 includes commands generated in a query language (e.g., SQL) by the machine-learning model 420 based on the natural language input 122. In particular, the query 422 is configured to include commands in the query language that are executable for retrieval of data 424 from the storage device 108 based on the comparison data 408, e.g., the data from the data tables associated with the center embeddings.

The recalled data 412 is provided to a result module 414. The result module 414 processes the recalled data 412 and generates the result 124 that is based on the information request described by the natural language input 122 (block 616). The result module 414 is operable to employ one or more machine learning models implemented by the machine-learning system 134, such as a machine-learning model 426, for generation of the result 124. For instance, the machine-learning model 426 may be a large language model (LLM) or other type of learning model configured to generate natural language content to be included in the result 124. The result 124 thus is configurable to include information from the recalled data 412 as well as natural language content generated by the machine-learning model 426. The natural language content can include, for instance, a description of how the information from the recalled data 412 relates to the natural language input 122.

By employing the described techniques for data recall using cluster-based embeddings, accuracy of recall of the data from the storage device 108 can be increased. For instance, the recalled data 412 is identified and recalled specifically based on the information request described by the natural language input 122. As a result, a volume of data transfer from the storage device 108 can be reduced relative to conventional approaches, thereby conserving data transfer bandwidth. Additionally, because the volume of data transfer is reduced, the computational load associated with processing the recalled data 412 is less than that associated with conventional approaches. As a result, consumption of resources such as memory and processor load can be reduced.

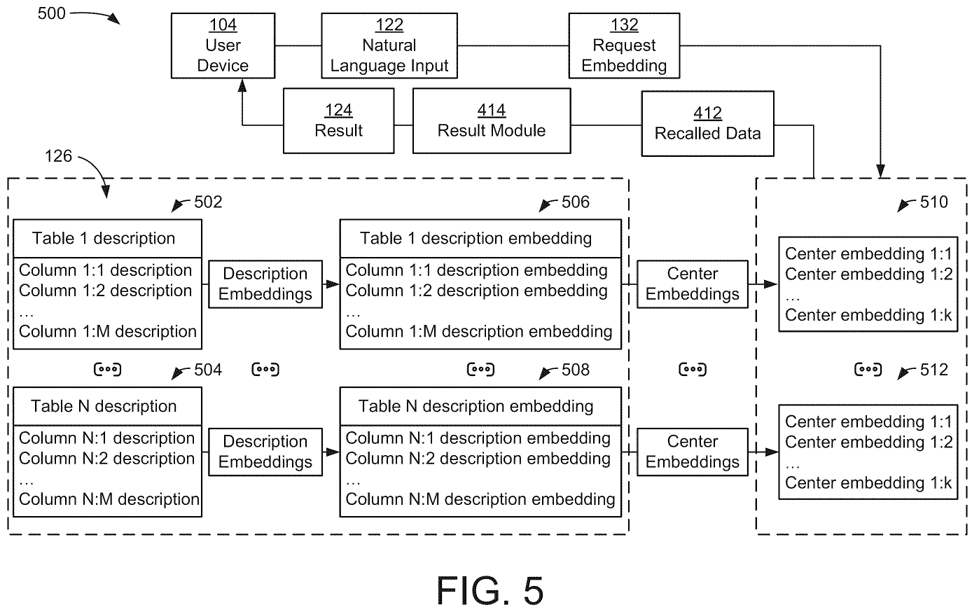

FIG. 5 depicts a system 500 in an example implementation showing operation of the query service of FIG. 1 in greater detail as employed to perform data recall using cluster-based embeddings. The depicted example shows a portion of table data 126 including descriptions 502 associated with a first table “table 1” and descriptions 504 associated with another table “table N.” The table data 126 is configurable to include one or more additional tables in order between “table 1” and “table N.” The example further depicts description embeddings 506 generated from the descriptions 502 associated with “table 1” and description embeddings 508 generated from the descriptions 504 associated with “table N.” The description embeddings 506 and the description embeddings 508 are included in the embedding data 304 generated by the query service using the embedding module 302, for instance. The depicted example additionally shows center embeddings 510 generated from the description embeddings 506 and center embeddings 512 generated from the description embeddings 508. The center embeddings 510 and the center embeddings 512 are included in the center embedding data 130 generated using the cluster data 128, for instance.

The center embeddings 510 and the center embeddings 512 can be generated in advance of receiving queries (e.g., information requests) via the query service 120. In doing so, the query service 120 is able to quickly identify information stored in the table data 126 based on the information request and provide the recalled data 412 to the result module 414 for output of the result 124. In particular, pre-defining the center embeddings supports recall of information from the table data 126 with decreased searching (e.g., reduced comparison of embeddings) and decreased computational load at the time information requests are received. As a result, a computational speed of the service provider system 102 is increased and a response time associated with query processing is reduced.

### Example System and Device

FIG. 7 illustrates an example system generally at 700 that includes an example computing device 702 that is representative of one or more computing systems and/or devices that implement the various techniques described herein. This is illustrated through inclusion of the query service 120. The computing device 702 is configurable, for example, as a server of a service provider, a device associated with a client (e.g., a client device), an on-chip system, and/or any other suitable computing device or computing system.

The example computing device 702 as illustrated includes a processing device 704, one or more computer-readable media 706, and one or more I/O interfaces 708 that are communicatively coupled, one to another. Although not shown, the computing device 702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 704 is representative of functionality to perform one or more operations using hardware. Accordingly, the processing device 704 is illustrated as including hardware elements 710 that are configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712 that stores instructions that are executable to cause the processing device 704 to perform operations. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.” “Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing device 704. The instructions and/or functions are executable/operable by one or more articles of manufacture (for example, one or more computing devices 702 and/or processing devices 704) to implement techniques, modules, and examples described herein.

The techniques described herein are supported by various configurations of the computing device 702 and are not limited to the specific examples of the techniques described herein. This functionality is also implementable all or in part through use of a distributed system, such as over a “cloud” 714 via a platform 716 as described below.

The cloud 714 includes and/or is representative of the platform 716 for resources 718. The platform 716 abstracts underlying functionality of hardware (e.g., servers) and software resources of the cloud 714. The resources 718 include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In implementations, the platform 716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method implemented by a computing device, the method comprising:
generating vector embeddings of one or more data columns based on descriptions associated with the one or more data columns;
determining, in a vector embedding space, one or more clusters of the vector embeddings based, at least in part, on a threshold similarity, the one or more clusters including a first cluster of vector embeddings associated with a first set of the one or more data columns;
generating center embeddings representative of the one or more clusters, the center embeddings including:
a first center embedding representative of the first cluster of vector embeddings associated with the first set of the one or more data columns;
obtaining, using the center embeddings, one or more data tables that include the one or more data columns;
generating, from an information request, a request embedding;
determining similarity between the request embedding and the center embeddings in a vector embedding space using a threshold similarity;
identifying, based on the determining, one or more of the data tables;
generating a result using information of the one or more tables. the result relating to the information request; and
outputting the result including the information.

2. The method of claim 1, further comprising receiving the information request as natural language input and generating a query in a query language for retrieval of the information based on the natural language input using a machine-learning model.

3. The method of claim 2, wherein the query language is structured query language (SQL) and the query includes structured query language (SQL) commands executable to retrieve the information from the one or more of data tables.

4. The method of claim 2, wherein the machine-learning model is a retrieval-augmented generation (RAG) model, and further comprising:
retrieving the information from the one or more of the data tables using the retrieval-augmented generation (RAG) RAG model;
providing the information from the retrieval-augmented generation (RAG) model to a large language model (LLM); and
outputting the result from the large language model (LLM).

5. The method of claim 4, wherein the result includes the information and natural language content generated by the large language model (LLM) based on the natural language input.

6. The method of claim 1, wherein each of the center embeddings is associated with a corresponding cluster of the one or more clusters and is an average of the vector embeddings on which the corresponding cluster is based.

7. The method of claim 1, wherein forming the determining of the one or more clusters of the vector embeddings includes determining the vector embeddings are associated with a set of data columns based, at least in part, on clustering the data columns corresponding to the embeddings based on the similarity between the vector embeddings.

8. The method of claim 7, wherein the determining of the one or more clusters of the vector embeddings based, at least in part on the threshold similarity includes clustering the one or more data columns based on the similarity between the vector embeddings being greater than the threshold similarity.

9. The method of claim 1, wherein the one or more data tables include one or more data tables represented by using two or more of the center embeddings.

10. The method of claim 1, wherein determining similarity between the request embedding and the center embeddings in the vector embedding space includes determining the similarity using a machine-learning model.

11. The method of claim 1, wherein the request embedding and the center embeddings are vectors, and determining similarity between the request embedding and the center embeddings in the vector embedding space includes comparing the vectors using a vector similarity function.

12. The method of claim 11, wherein the vector similarity function is a cosine similarity function.

13. A computing device comprising:
a processing device; and
a computer-readable storage medium storing an application and instructions that, responsive to execution by the processing device, causes the processing device to perform operations including:
generating vector embeddings for one or more data columns based on descriptions associated with the one or more data columns;
determining, in a vector embedding space, one or more clusters of the vector embeddings based, at least in part, on a threshold similarity, the one or more clusters including a first cluster of vector embeddings associated with a first set of the one or more data columns;
generating center embeddings representative of the one or more clusters, the center embeddings including:
a first center embedding representative of the first cluster of vector embeddings associated with the first set of the one or more data columns;
obtaining, using the center embeddings, one or more data tables that include the one or more data columns;
generating, from an information request, a request embedding;
determining similarity between the request embedding and the center embeddings in a vector embedding space using a threshold similarity;
identifying, based on the determining, one or more of the data tables;
generating a result using information of the one or more tables, the result relating to the information request; and
outputting a result including the information.

14. The computing device of claim 13, the operations further including receiving the information request as natural language input and generating a query in a query language for retrieval of the information based on the natural language input using a machine-learning model.

15. The computing device of claim 14, wherein the query language is structured query language (SQL) and the query includes structured query language (SQL) commands executable to retrieve the information from the one or more data tables.

16. The computing device of claim 14, wherein the machine-learning model is a retrieval-augmented generation (RAG) model, and the operations further include:
retrieving the information from the one or more data tables using the retrieval-augmented generation (RAG) model;
providing the information from the retrieval-augmented generation (RAG) model to a large language model (LLM); and
outputting the result from the large language model (LLM).

17. The computing device of claim 13, wherein determining of the one or more clusters of the vector embeddings includes determining the vector embeddings are associated with a set of data columns based, at least in part, on and clustering the data columns corresponding to the embeddings based on the similarity between the vector embeddings.

18. A non-transitory computer readable medium comprising instructions that when executed cause one or more processors to perform operations including:
generating vector embeddings of one or more data columns based on descriptions associated with the one or more data columns;
determining, in a vector embedding space, one or more clusters of the vector embeddings based, at least in part, on a threshold similarity, the one or more clusters including a first cluster of vector embeddings associated with a first set of the one or more data columns;
generating center embeddings representative of the one or more clusters, the center embeddings including:
a first center embedding representative of the first cluster of vector embeddings associated with the first set of the one or more data columns;
obtaining, using the center embeddings, one or more data tables that include the one or more data columns;
generating, from an information request, a request embedding;
determining similarity between the request embedding and the center embeddings in a vector embedding space using a threshold similarity;
identifying, based on the determining, one or more of the data tables;
generating a result using information of the one or more tables, the result relating to the information request; and
outputting a result including the information.

19. The non-transitory computer readable medium of claim 18, wherein each of the center embeddings is associated with a corresponding cluster of the one or more clusters and is an average of the vector embeddings on which the corresponding cluster is based.

20. The non-transitory computer readable medium of claim 18, wherein the one or more data tables one or more data tables represented by two or more of the center embeddings.
